(19) United States
(12) Patent Application Publication
(10) Pub. No.: US 2022/0119916 A1
(43) Pub. Date: Apr. 21, 2022

(54) METHODS OF BASE METAL RECOVERY WITH APPLICATIONS OF OXYGEN VECTORS

(71) Applicant: American Air Liquide, Inc., Fremont, CA (US)

(72) Inventors: Sumedh GOSTU, Newark, DE (US); Min Ho MAENG, Newark, DE (US); Timothy L. MURRAY, Newark, DE (US)

(21) Appl. No.: 17/072,788

(22) Filed: Oct. 16, 2020

(51) Int. Cl. C22B 3/00; C22B 3/12

(52) U.S. Cl. CPC C22B 11/04; C22B 3/12

(57) ABSTRACT

In described embodiments, a process for recovery of a metal from a grounded ore comprises leaching the grounded ore with a leaching reagent, an oxidant and an oxygen vector. In particular, a process for recovery of gold from a grounded gold ore, comprises leaching the grounded gold ore with a cyanide salt, an oxidant and an oxygen vector. The oxygen vector is selected from dodecane, decane, hexadecane, or the like.

### TECHNICAL FIELD

The present invention relates to a process for recovery of a metal from a grounded ore comprising leaching the grounded ore with a leaching reagent, an oxidant and an oxygen vector. In particular, a process for recovery of gold from a grounded gold ore, comprising leaching the grounded gold ore with a cyanide salt, an oxidant and an oxygen vector. The oxygen vector is dodecane, decane, hexadecane, or the like.

### BACKGROUND

Hydrometallurgical leaching refers to the process of selectively dissolving metals of interest employing suitable chemical reagents/lixiviants. In the case of gold leaching, cyanide salts in the form of sodium or calcium cyanide are used to selectively dissolve gold and silver from ores. In addition, cyanide acts as a strong complexing agent with gold (compared to gold chloride and thiosulfate complexes). Cyanide complexation assists in reduction of the standard reduction potential of Au dissolution (oxidation); thereby forming a redox couple with oxygen as shown in the following Equations (1)-(5).

Au⁺(aq)+e⁻→Au E°=1.68 V (1)

Au(CN)²⁻(aq)+e⁻→Au(s)+2CN⁻(aq)(Anodic Reaction) (2)

O₂(g)+2H⁺+2e⁻→2H₂O₂(aq)E°=0.682 V(Cathodic Reaction) (3)

2H₂O₂→O₂(aq)+2H₂O(aq) (4)

O₂(g)+2H₂O(aq)+4e⁻→4OH⁻(aq)E°=0.401 V (5)

Gold leaching is governed by the complexation reaction (Equation (2)) and presence of oxidant (Equations (3)-(5)) to achieve desirable leach kinetics.

4Au+8CN⁻+O₂+2H₂O→4Au(CN)²⁻+4OH⁻ (6)

Equation (6), also called the Elsner equation, shows the need for O₂ and CN⁻ for gold leaching, ideally a [CN⁻]/[O₂]=6/1 is present to dissolve Au at an optimal rate from oxide ores. As the ores become more complex, the optimal [CN⁻]/[O₂] to achieve greater dissolution rate becomes different. Leaching is usually conducted in the alkaline regime (e.g., pH>10) to avoid the loss of cyanide as poisonous Hydrogen cyanide gas.

Traditional ore types are oxides and contain easily accessible gold particulates. Even in the presence of minor sulfides, the gold is relatively easy to access and is not classified as refractory. Oxygen requirements for Equation (6) above can be achieved with mere air injection into the slurry for oxidized ores.

Over the past few decades as leaner ore grades are being mined, more and more gold is found locked up in sulfidic matrix, concentrates containing cyanicides (Fe, Cu), and concentrates containing preg-robbers (carbonaceous material adsorbing gold) leading to increase in refractory and double refractoriness. The changing refractoriness of ores is associated with an increase in consumption of reagents viz, cyanide and oxygen and decrease in gold leaching kinetics (Deschenes, G. “Advances in the cyanidation of gold.” Developments in Mineral Processing 15 (2005): 479-500).

Labile sulfide (Pyrrhotite (Fe₇S₈), Marcasite (FeS₂) and Arsenopyrite (FeAsS) (to an extent) oxidation cannot be avoided in oxidative gold leaching irrespective of the presence of encapsulated gold or not. Present day mines are shifting towards using oxygen in cyanide leaching circuit and pre-oxygenation treatment prior to the leaching step (Marsden et al. “The chemistry of gold extraction”, SME, 2006; Lotz et al. “Aachen Reactors, a system to realize hidden economic potentials”, World Gold Conference, 2015). The pre-oxidation treatments aim at oxidizing the sulfides, in some cases passivating the surface of active sulfides with the formation of Iron hydroxides and liberating the encapsulated gold accessible by cyanide for the next stage of the process. The passivation process with marcasite is described in Equation (7). Similar passivation is achieved with pyrrohotite and arsenopyrite.

4FeS₂+15O₂+14H₂O→4Fe(OH)₃+16H⁺+8SO₄⁻² (7)

The choice of oxidation treatment depends on the level of sulfide matrix needed to liberate the encapsulated gold. The chosen alternative depends on the nature of sulfides and level of gold deportment. There are two main kinds of oxidative treatments: pyrometallurgical and hydrometallurgical oxidations. Pyrometallurgical treatments involve roasting to oxidize sulfur, arsenic and organic carbon. It is usually avoided due to its negative environmental impact. Hydrometallurgical treatments include:
Pressure oxidation: it is usually associated with the complete oxidation of sulfidic matrix to liberate fine disseminated gold for cyanide leaching. Pressure oxidation treatment is usually not preferred due to high capital expenditure (CAPEX) involved.
Biological oxidation: It is associated with the complete destruction of sulfide matrix employing bacteria.
Atmospheric pre-oxidation: it is preferably carried out in alkaline pH conditions, and associated with oxidation of labile sulfides, formation of passivation layer, and liberating superficially accessible gold for cyanide leaching.

Atmospheric pre-oxidation of sulfide matrix or oxidation of Au in the cyanide leaching stage is mostly a diffusion-controlled reaction, limited by the reactants (O₂ and CN) diffusion through the Nernst boundary layer (Zhang et al. “Application of n-dodecane as an oxygen vector to enhance the activity of fumarase in recombinant Escherichia coli: role of intracellular microenvironment”, Brazilian Journal of Microbiology, 49.3 (2018): 662-667). Zhang et al. studied the effect of oxygen vector (n-hexane, n-dodecane, and n-hexadecane) on the activity of fumarase in recombinant Escherichia coli fermentation. The addition of 2.5% n-dodecane increased the activity of fumarase to 124% and the concentration of ATP to 7600% compared with the no oxygen vector condition. Cyanide being more expensive reagent compared to oxygen, it is desirable from a financial standpoint that the dissolution of gold in alkaline cyanide solutions is controlled by the rate of dissolution of oxygen from bulk solution to solid reactant surface (Flatman et al., Twenty years of Development to Commercial Demonstration of the Aachen Reactor. Precious Metals '15, Falmouth, UK. Minerals Engineering Conference, 2015). In a reaction limited by diffusion of oxygen, the thickness of the boundary layer is limited inversely dependent on the amount of agitation or shear employed in the system (Nicol et al., “The chemistry of the extraction of gold”, Mintek, 831-905, 1987). The smaller the film boundary layer, the faster is the kinetics of oxidation and dissolution, and the faster is the diffusion of products away from the solid surface as well. Commonly available continuous stirred-tank reactors (CSTRs) are in the Reynolds number regime of 0.5-1.5 which puts them in the laminar to turbulent regime, while the new shear reactors being developed for the industry function in the Reynolds 15,000 turbulent regime. “Shear reactors” for gold leaching refer to side stream units for the conventional CSTRs used for gold leaching applications. These shear reactors inject additional oxygen to the gold leaching slurry, the slurry is forced under turbulence through the shear reactor. The existing side stream shear reactors are known to increase the oxygen mass transfer in gold leaching with the application of shear and particle breakage. The associated benefits do come at an increased CAPEX and operating expense (OPEX) for the end user (operating mines).

Oxygen mass transfer (OMT) from gas to liquid phase has been a widely researched topic in many fields, such as, biochemical, petrochemical, wastewater treatment and some aqueous processes, in oxidative leaching processes employed for gold, copper, cobalt, zinc and lead, OMT is a critical parameter since oxygen constitutes a major portion of the OPEX. In the mining industry, the problem of OMT has always been counteracted in a way by increasing agitation, shear, lance positions, diffusion, or micro- and nano-bubble generations. While some of these solutions have achieved the desired O₂ solubility, most of the options available today are energy, material, CAPEX and OPEX intensive.

Oxygen vectors (i.e., higher carbon chain organic solvents) possess higher oxygen solubility compared to the aqueous system. On the application of mechanical agitation, directional localized diffusion of oxygen occurs from the solvent to the aqueous liquid phase, hence termed as vectors.

Oxygen vector in fermentation processes and wastewater treatment has been used. Organic liquids like n-hexane, n-heptane, toluene, ethanol, heptanol, octanol, oleic acid, kerosene, etc., were used in increasing OMT in fermentation cell culture medium. Some of the organic solvents were also used in wastewater treatment. Several studies (see below) have shown that oxygen vector can enhance the oxygen mass transfer rate, thus improving the performance of aerobic fermentation processes. These research publications used air as oxygen source and do not consider oxygen vector for the metal leaching processes.

Rols et al. (“Mechanism of enhanced oxygen transfer in fermentation using emulsified oxygen-vectors” Biotechnology and Bioengineering 35.4 (1990): 427-435) used n-dodecane and perfluorocarbon (forane F66E) as oxygen vector in an aerobic fermentation experiment. Air was injected as oxygen sources at atmospheric pressure. The results showed that Aerobacter aerogens enabled a 3.5 fold increase of volumetric oxygen transfer coefficient (K_{La}) with n-dodecane.

Jia et al. (“Enhancement of yeast fermentation by addition of oxygen vectors in air-lift bioreactor”, Journal of Fermentation and Bioengineering, 84.2 (1997): 176-178) used n-dodecane and perfluorocarbon for yeast fermentation in air-lift bioreactor. The yeast concentration increased by 20% when using 3% (v/v) of n-dodecane compared with the no oxygen vector condition.

Galaction et al. (Galaction, Anca-lrina, et al, “Enhancement of oxygen mass transfer in stirred bioreactors using oxygen-vectors. 1. Simulated fermentation broths.” Bioprocess and Biosystems Engineering 26.4 (2004): 231-238) tested a simulated fermentation broths using n-dodecane as oxygen vector under submerged and surface aeration modes. The considerable increase of K_{La} was observed in presence of n-dodecane.

Galaction et al. (“Enhancement of oxygen mass transfer in stirred bioreactors using oxygen-vectors 2. Propionibacterium shermanii broths”, Bioprocess and Biosystems Engineering, 27.4 (2005): 263-271) repeated the same test with non-respiring P shermanii suspension and confirmed that n-dodecane can contribute to the considerable increase of K_{La} in a stirred bioreactor system.

Folescu et al. (“Enhancement of oxygen mass transfer in pneumatical bioreactors using n-dodecane as oxygen-vector”, Environmental Engineering and Management Journal, November 2012, Vol. 11, No, 11, 1953-1961) used n-dodecane to improve oxygen mass transfer for aerobic fermentation in pneumatically agitated bioreactor (bubble column and air-lift bioreactor). They practiced with humidified air and distilled water to determine K_{La}. The results showed that K_{La} was increased by 100% under low volumetric fraction of n-dodecane (0.005, v/v) at 35° C.

Xu et al. (“Effects of oxygen-vectors on the synthesis of epsilon-poly-lysine and the metabolic characterization of Streptomyces albulus PD-1”, Biochemical Engineering Journal, 94, 58-64 (2015) describes the production of epsilon-poly-lysine (ε-PL) was enhanced by adding oxygen-vector to the culture broth of Streptomyces albulus PD-1.

Bo et al. (2015 Effects of oxygen-vectors on the synthesis of epsilon-poly-lysine and the metabolic characterization of Streptomyces albulus PD-1”, Biochemical Engineering Journal, 94, 58-64 (2015)) selected n-dodecane as the best oxygen-vector to enhance the production of ε-poly-L-lysine (ε-PL) in a fed-batch fermentation. With the addition of 0.5% (v/v) of n-dodecane, the concentrations of ε-PL and dry cell weight increased by 31.6% and 20.7% compared to the control group without oxygen vector. The results indicated that the dissolved oxygen level in the broth was improved by adding n-dodecane (23.8% to >32% of air concentration).

Westbrook et al. (“Application of hydrocarbon and perfluorocarbon oxygen vectors to enhance heterologous production of hyaluronic acid in engineered Bacillus subtilis”, Biotechnology and bioengineering, 115.5 (2018), 1239-1252) applied oxygen vectors to produce hyaluronic acid (HA) by engineered Bacillus subtilis fermentation. The significant improvements to the HA titer and/or cell density were observed in cultures containing n-heptane, n-hexadecane, perfluoromethyldecalin, and perfluoro-1,3-dimethylcyclohexane.

Chavan (“Oxygen Mass Transfer in Biological Treatment System in the Presence of Non-aqueous Phase Liquid”, APCBEE Procedia 9 (2014): 54-58) studied the effect of oxygen vector on the oxygen mass transfer in wastewater treatment processes. Soybean oil was selected as oxygen vector to improve the oxygen mass transfer in Jar apparatus. The value of K_{La} was found to increase by 30% in the presence of soybean oil compared to absence of soybean oil. The use of oxygen vectors to increase OMT in a hydrometallurgy based stirred reactor system is relatively new. Organic liquids like n-hexane, n-heptane, toluene, ethanol, heptanal, octanol, oleic acid, kerosene, etc., were used in increasing OMT in fermentation cell culture medium.

Sinha et al. (“Aqueous process intensification through enhanced oxygen mass transfer using oxygen vector: An application to cleaner leaching”, Journal of Cleaner Production 176 (2018): 452-462) discloses some of the organic solvents were also used in wastewater treatment. The possibility of using oxygen vector for copper leaching in POX (pressure oxidation) processes. More than 95% dissolution rate of Cu, Ni and Co was achieved with 2.5% (v/v) n-dodecane under moderate temperature-pressure conditions. They suggested n-dodecane can be recovered and re-used in subsequent leaching trials due to its inert property. However, none of these references relate to gold pre-oxidation and the cyanidation circuit.

### SUMMARY

There is disclosed a process for recovery of a metal from a grounded ore, comprising the step of:

leaching the grounded ore with a leaching reagent, an oxidant and an oxygen vector.

In some embodiments the process further comprising the steps of floating the grounded ore to obtain an ore concentrate; and feeding the ore concentrate to the leaching step.

In some embodiments the process further comprising the steps of pre-oxidizing the ore concentrate and the grounded ore using the oxidant and the oxygen vector to obtain a slurry; and feeding the slurry to the leaching step.

In some embodiments, the metal is gold, copper, lead, nickel, zinc or cobalt.

In some embodiments the leaching reagent is a cyanide salt.

In some embodiments the cyanide salt is selected from one or more of KCN, NaCN or Ca(CN)₂.

In some embodiments, the leaching reagent is an alkaline.

In some embodiments, the oxygen vector is dodecane, decane or hexadecane.

In some embodiments, a weight of the oxygen vector in the pre-oxidation and/or cyanide leaching mixtures ranges from 1% to 6% by weight.

In some embodiments, the oxidant is a mixture of air, O₂ and H₂O₂.

In some embodiments, a temperature of operation ranges from 10° C. to 70° C.

In some embodiments, a pH of the leaching process ranges 1-4 and 8-11.5.

In some embodiments, a pH of the pre-oxidation process ranges 1-4 and 8-11.5.

There is also disclosed a process for recovery of gold from a grounded gold ore, comprising the step of:

leaching the grounded gold ore with a cyanide salt, an oxidant and an oxygen vector.

In some embodiments the process further comprising the steps of floating the grounded gold ore to obtain a gold ore concentrate; and feeding the gold ore concentrate to the leaching step.

In some embodiments the process further comprising the steps of pre-oxidizing the gold ore concentrate and the grounded gold ore using the oxidant and the oxygen vector to obtain a slurry; and feeding the slurry to the leaching process.

In some embodiments, the oxygen vector is dodecane, decane or hexadecane.

In some embodiments, the cyanide salt is selected from one or more of KCN, NaCN or Ca(CN)₂.

In some embodiments, a pH of the leaching process is >9.

In some embodiments, a pH of the pre-oxidation process is >9.

In some embodiments, a temperature of operation ranges from 10° C.-76° C.

In some embodiments, the oxidant is a mixture of air, O₂ and H₂O₂.

There is also disclosed a process for recovery of a gold from a grounded gold ore, comprising the steps of:

floating the grounded gold ore to obtain a gold ore concentrate;

pre-oxidizing the gold ore concentrate and the grounded gold ore using the oxidant and an oxygen vector and a mixture of air, O₂ and H₂O₂ to obtain a slurry; and

leaching the slurry, the gold ore concentrate and the grounded gold ore with NaCN, the oxygen vector and the mixture of air, O₂ and H₂O₂, wherein the oxygen vector is selected from dodecane, decane or hexadecane.

In some embodiments a total percentage (%) increase of a gold recovery is 0.2%-1.6% with oxygen and oxygen vector versus oxygen injection only.

### BRIEF DESCRIPTION OF THE DRAWING

For a further understanding of the nature and objects of the present invention, reference should be made to the following detailed description, taken in conjunction with the accompanying drawings, in which like elements are given the same or analogous reference numbers and wherein:

FIG. 1 is a flow chart of an exemplary embodiment of a gold leaching process.

### DESCRIPTION OF PREFERRED EMBODIMENTS

Disclosed are methods of a base metal recovery with applications of oxygen vectors. More specifically, the disclosed are the methods of using oxygen vectors (i.e., organic solvents) in a leaching process to increase oxygen mass transfer (OMT) in a real metal-based hydrometallurgical system. The disclosed methods may include a pre-oxidation process in which the oxygen vector is added to an oxidant. A flotation process may be included to obtain an ore concentrate before pre-oxidation process. A comminution process may be applied to get a crushed and grounded ore for the flotation process. The base metal includes gold, copper, lead, nickel, cobalt or the like. The oxygen vector may be a higher carbon chain organic solvent, such as dodecane, decane and hexadecane.

The applications of the oxygen vectors in existing metal leaching and pre-oxidation reactors have the following benefits:
Larger mineral liberation for the same oxygen utilization, which could extend existing comprehensive metal leaching systems for additional mineralogies. For example, gold does not present on the surface, but presents inside resistant sulfide minerals, like Arsenopyrite.
Reduced residence time in process systems that could imply an increase in existing process throughput.
Enhancement of the OMT in existing reactors.

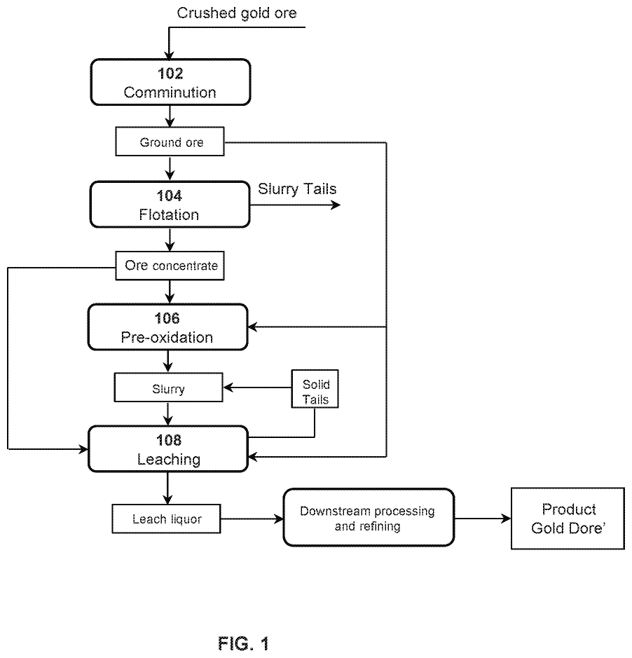

In one embodiment, the disclosed method is applied to extract gold from a gold ore concentrate. Commercially, the gold ore/concentrate is treated by employing a hydrometallurgical leaching process to dissolve gold into a solution phase. The solution phase is then subjected to additional concentration and stripping of gold. The final product after all the back end processing is a gold doré. A generalized flowchart for gold extraction of the disclosed method is shown in FIG. 1, a flowchart of an exemplary embodiment of a gold-cyanide leaching process. As shown, a gold ore is mined from open pit or underground mining operations and then crushed. The crushed gold ore is subjected to a series of crushing and grinding operations, i.e., comminution operation at step 102 to obtain a fine ground gold ore. The objective of the comminution operation is to reach a desired gold ore particle size suitable for further downstream processing. At step 104, the fine ground gold ore is optionally treated by flotation. The flotation is a physical separation technique used to concentrate the gold bearing sulfidic minerals in lieu of their surface specificity by adding a flotation reagent. The flotation reagent may be aerofloat series or xanthates. The flotation technique is applied to certain ore mineralogies amenable for surface assisted separation. A product of the flotation is called as an ore concentrate or a flotation concentrate. A slurry tails from the flotation process is discharged. Here the ground ore from comminution or the flotation concentrate from flotation is then subjected to pre-oxidation with an oxidant injection at step 106. The oxidant may be a mixture of air, O₂ and H₂O₂. The pre-oxidation could include any one of the techniques described in the background. The pre-oxidation is optional and dependent on the amount and quantities of oxygen consuming compounds (e.g., sulfides) and the shape and size of gold particles and the association of the gold bearing particles in the oxygen consuming compound matrix. In this step, an oxygen vector may be add to the oxidant to increase OMT. The oxygen vector may be dodecane, decane, hexadecane, or the like. The pre-oxidation treatment prior to cyanide leaching (step 108) liberates or frees the locked gold and contributes to cyanide reagent savings in the subsequent cyanide leaching operation. The product of the pre-oxidation is a pre-oxidation slurry. The ground ore, flotation ore concentrate, pre-oxidized slurry (i.e., precursor) and combinations thereof are then subjected to cyanide leaching to selectively dissolve the gold at step 108. Cyanide salts addition and air/O₂/H₂O₂ injection are performed on the precursors. The cyanide salts may be potassium cyanide (KCN), sodium cyanide (NaCN) and calcium cyanide (Ca(CN)₂). The cyanide salt may be selected from one or more of KCN, NaCN or Ca(CN)₂. The gold particles in the precursors is complexed to form a gold cyanide complex selectively leaving undissolved gangue (impurities) in a residue. In this step, the oxygen vector may be add to the cyanide salt and the oxidant to increase OMT, The oxygen vectors may be dodecane, decane, hexadecane, or the like. The leach liquor from the leaching process is then subjected to downstream processing and refining operations to produce a gold doré (e.g., 80% Gold). The gold dorés are subsequently refined in protected government facilities (i.e., mints) to produce a gold bar. A solid tail from the leaching process may be recycled back to the pre-oxidation slurry.

The disclosed methods use oxygen vectors, such as, dodecane, decane and hexadecane, in atmospheric leaching processes for metal recoveries. The oxygen vectors increase the mass transfer of oxygen from gas phase to liquid phase. The oxygen vectors are added in-situ into the leaching step and are recovered back into the process using gravity. The metal recovery is not limited to gold but may be applied to any metal leaching using oxygen as one of the reactants/oxidants. The metals of interest could be extended to copper, lead, nickel, cobalt or the like. In particular, referring to gold leaching, the above mentioned oxygen vectors may be applied in the pre-oxidation and/or cyanide leaching unit operation. The associated benefits of using oxygen vectors in gold leaching may be envisaged in terms of increased gold recovery and decreased cyanide consumption.

The ranges of parameters and benefits, which could be employed for this application in reference to gold in pre-oxidation and cyanide leaching, include:
Wt % of oxygen vector addition: 1%-6% w/w % of the pre-oxidation and/or cyanide leaching mixtures;
Temperature of operation: 10° C.-70° C.;
pH: 8-11.5; preferably pH>9;
Dissolved oxygen in liquid in range of: 5 ppm to 40 ppm;
Total % increase of gold/metal recovery: 0.2%-1.6% with oxygen and oxygen vector versus oxygen injection only;
Leaching reagent sodium cyanide (kg NaCN/t of ore) savings: 8%-33% with oxygen and oxygen vector versus oxygen injection only;
Oxygen consumption reduction (kg of O₂/t of ore): 10-26% on the application of oxygen and solvent versus oxygen addition only.

Here, the pH in pre-oxidation and leaching may vary depending on the leaching reagent that is applied. For example, for some metals, an alkaline may not be used as a leaching reagent; the pH may range from 1 to 4. Thus, the overall pH for metal recoveries may range from 1 to 4 and 8 to 11.5.

### EXAMPLES

The following non-limiting examples are provided to further illustrate embodiments of the invention. However, the examples are not intended to be all inclusive and are not intended to limit the scope of the inventions described herein.

### Example 1. Gold Recovery

A gold ore concentrate chosen for this example has significant oxygen demands, which may not be sustained using air. A set of 5 tests were performed for pre-oxidation and cyanide leaching using air, O₂ and O₂+ each of the selected oxygen vectors in a reactor shown in Table 1. The selected oxygen vectors have a higher boiling point compared to the desired temperature of operation (e.g., 25-35° C.), high oxygen capacity, lower density and a lower water solubility (facilitates separation and reuse of solvents after unit operation).

TABLE 1
Properties of Different Oxygen Vectors

| | | | | Solubility | | V. P. | |
|---|---|---|---|---|---|---|---|
| | | | | in water | O₂ | (Pa) | |
| | B.P. | M.P. | Density | (ppm) | solubility | @ | |
| 11.5 | (° C.) | (° C.) | (g/cc) | 25° C. | (xL*10\hat{ }3) | 25° C. | Hazards |
| n-Hexane | 69 | −95 | 0.6603 | 9.5 | 1.96 | | Flammable |
| (Colorless) | | | | | | | 1.1%-7.5% |
| Toluene | 110.7 | −95 | 0.866 | 526 | 0.922 | | Flammable, |
| (Colorless) | | | | | | | Corrosive |
| n-Heptane | 98.38 | −90 | 0.6795 | 0.0034 | 1.94 | | Highly flammable, |
| | | | | | | | corrosive, toxic |
| n-Decane | 173 | −30 | 0.73 | 0.052 | 2.2 | 195 | Flashpoint 46° C., |
| | | | | | | | Flammable |
| | | | | | | | (LFL 0.7 vol %, |
| | | | | | | | UFL 5.4 vol %) |
| n-Dodecane | 218 | −9.55 | 0.749 | 0.0037 | 1.86 | 18 | Flammable, |
| | | | | | | | Flashpoint 7l° C., |
| | | | | | | | (LFL 0.6 %, |
| | | | | | | | UFL no data) |
| n- | 287 | 18 | 0.77 | 0.000021 | 1.74 | 0.3 | Not flammable, |
| Hexadecane | | | | | | | health hazard |
| Octanol | 195 | −16 | 0.83 | 1120 | 1.132 | | Corrosive, irritant |
| Hexanol | 157 | −45 | 0814 | 5900 | | | |

Increase in oxygen mass transfer is known to increase gold recovery and reduce the consumption of sodium cyanide. Total five sets of batch experiments were carried out as the preliminary tests: only air, only O₂, decane+O₂, dodecane+O₂ and hexadecane+O₂.

For homogenizing the gold ore concentrate samples, the homogenizing technique was used. Percent solids and percent moisture determinations were made for each sample. The ore was processed in a 2.3 liter glass vessel with the following capabilities: temperature control (at 25° C.) via a heating jacket and cooling loop, pH control (at 10.5) with Ca(OH)₂ pumped in, dissolved oxygen control using optical DO (dissolved oxygen) probe, inlet gas (O₂ and N₂) control. Here N₂ is used to maintain a dissolved oxygen concentration. For example, a ratio of N₂ and O₂ was 50% N₂ versus 50% O₂. The pH probe and the two DO probes were calibrated prior to the start of each run. A leak test was performed after the reactor and all of its parts were assembled. The oxygen vector solvent was then added through a port in the lid at 2 volume % of the slurry volume.

Referring to FIG. 1, pre-oxidation (step 106) started when the desired pH (10.5) and temperature (25° C.) were reached. A sample was taken and the oxygen and nitrogen flow was started to achieve the desired DO concentration (10 mg/L), Here nitrogen is used to maintain a dissolved oxygen level in the process along with oxygen. Oxygen Uptake Rates (OUR) were taken at 0.25 hr, 1 hr, 2 hr, 4 hr, 8 hr and 13 hr. During the OUR measurements, the gas in and gas out were turned off, the reactor was isolated and the mixing rpm (rotation per minute) was reduced. An additional sample was taken at 13 hr at the end of pre-oxidation.

Before the cyanide leaching (step 108) was started, the volume of the slurry was estimated and the temperature (25° C.), DO (15 mg/L) and pH (11.25) were adjusted. The free cyanide concentration was controlled to 1000 ppm by adding 10% NaCN based on slurry volume. OUR measurements and samples were taken at 1 hr (OUR only), 2 hr, 5 hr, 12 hr, and 24 hr times. During the OUR measurements, the gas in and gas out were turned off, the reactor was isolated and the mixing rpm was reduced. After measuring CN in the filtered samples by an ion sensitive electrode (ISE) CN probe, the residual CN in the reactor was adjusted to 800 ppm by adding the 10% NaCN solution through a port in the lid, After 24 hours, the slurry from the reactor was filtered (and washed with 2.5 L of DI water) and the dried solids were collected and sent for assaying. The unused Ca(OH)₂ was collected and weighed to estimate the CaO consumption.

Summary or the reaction parameter used for this example are:
a. Oxygen vector solvent addition: in experiments with solvent, 2 vol % of solvent is added.
b. Pre-oxidation: 25° C., 45% solids, pH 10.5, DO 10 ppm and 13 hour reaction time.
c. Cyanide Leaching: 25° C., 45% solids, 800 ppm free CN concentration, DO 15 ppm, 24 hour reaction time.

At the completion of every experiment, the solid residues and leach liquors are weighed and collected. The solids were assayed for gold, sulfur (total sulfur, sulfide sulfur and sulfate) and silver. The liquids were analyzed for gold, silver and anions (thiosulfate, sulfate and thiocyanate) respectively.

### Example 2: Gold Concentration

Gold concentration in solid residues were carried out using gold fire assay technique. Gold recovery presented in Table 2 was calculated using gold (g/t) remaining in the residue,

TABLE 2
Gold Recovery Table for Flextime Experiments

| Condition | Au Recovery % |
|---|---|
| Dodecane + O₂ | 87.17% |
| Hexadecane + O₂ | 87.48% |
| Oxygen | 87.05% |
| Air | 86.63% |
| n-Decane + O₂ | 88.62% |

As presented in Table 2, it can be seen that in experiments using n-Decane repeat experiment performed as an oxygen vector, about 1.5% (4 million $) increase in gold recovery was obtained compared to the no solvent (oxygen case). In general, an increasing trend for gold recovery was observed with a solvent addition viz: about 0.5% increase with Hexadecane, about 0.12% increase with dodecane. An increase in gold recovery was seen with the addition of a lowest carbon chain alkane (n-Decane) at about 1.5%. Here the gold recovery increase is calculated as a total increase.

### Example 3: Cyanide Consumption

Free cyanide concentration was monitored in the gold leaching slurry at the following times in cyanide leaching: 2 h, 5 h, 12 h and 24 h. The measurement was conducted using ISE CN probe. 1000 ppm free Cyanide was maintained initially, followed by an 800 ppm free CN concentration for the remainder of the experiment. 10% Sodium Cyanide was used to adjust the cyanide content.

TABLE 3
Sodium Cyanide Consumption in Flextime Experiments

| | Sodium Cyanide |
|---|---|
| Experimental Case | consumption (kg/t) |
| 2 wt % Dedecane + O₂ | 2.2 kg/t |
| 2 wt % Hexadecane + O₂ | 2.8 kg/t |
| Oxygen | 3.2 kg/t |
| Air | 4.4 kg/t |
| 2 wt % Decane + O₂ | 2.9 kg/t |

From Table 3, there is a decrease of about 28% in sodium cyanide consumption in case of oxygen compared to air. The experiments with the oxygen vectors displayed a decrease in sodium cyanide consumption compared oxygen: about 31% in case of dodecane (savings of 700,000 $), viz 12.5% in case of hexadecane and about 10% in case of decane (savings of 200,000 $).

### Example 4: Oxygen Consumption

The total oxygen consumption in experiments (pre-oxidation and cyanide leaching) was calculated using the Oxygen Uptake Rate studies performed as mentioned in section 2 under methodology and experimentation. Table 4 presents the Oxygen Consumption (kg of O₂/t of ore) utilized in the experiments.

TABLE 4
Total Oxygen Uptake (kg of solids) Utilized in the Flextime Tests

| | Total oxygen uptake | Preox O₂ | CNL O₂ |
|---|---|---|---|
| | (kg of O₂/mt | (kg of O₂/mt | (kg of O₂/mt |
| Test | of solids) | of solids) | of solids) |
| Dodecane + O₂ | 3.82 | 3.7 | 0.12 |
| Hexadecane + O₂ | 3.47 | 3.33 | 0.14 |
| Oxygen | 3.9 | 3.8 | 0.1 |
| Decane + O₂ | 2.88 | 2.76 | 0.12 |

Majority of the oxygen used was consumed during the pre-oxidation stage of the reaction. The above observation could be correlated to the passivation of labile sulfides in the pre-oxidation stage as iron hydroxides. These hydroxides do not participate in the cyanide leaching. In general, compared to experiments with no solvent addition, a decrease in oxygen consumption was observed with the addition of oxygen vectors.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used herein, the indefinite article “a” or “an” s used in this application and the appended claims should generally be construed to mean “one or more” unless specified otherwise or clear from context to be directed to a singular form.

As used herein, “about” or “around” or “approximately” in the text or in a claim means±10% of the value stated.

The standard abbreviations of the elements from the periodic table of elements are used herein. It should be understood that elements may be referred to by these abbreviations (e.g., Au refers to gold, etc.).

Additionally, the term “or” is intended to mean an inclusive “or” rather than an exclusive “or”. That is, unless specified otherwise, or clear from context, “X employs A or B” is intended to mean any of the natural inclusive permutations, That is, if X employs A; X employs B; or X employs both A and B, then “X employs A or B” is satisfied under any of the foregoing instances.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

Ranges may be expressed herein as from about one particular value, and/or to about another particular value. When such a range is expressed, it is to be understood that another embodiment is from the one particular value and/or to the other particular value, along with all combinations within said range.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Although the subject matter described herein may be described in the context of illustrative implementations to process one or more computing application features/operations for a computing application having user-interactive components the subject matter is not limited to these particular embodiments, Rather, the techniques described herein can be applied to any suitable type of user-interactive component execution management methods, systems, platforms, and/or apparatus.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A process for recovery of a metal from a grounded ore, comprising the step of leaching the grounded ore with a leaching reagent, an oxidant and an oxygen vector.

2. The process of claim 1, further comprising the steps of
floating the grounded ore to obtain an ore concentrate; and
feeding the ore concentrate to the leaching step.

3. The process of claim 2, further comprising the steps of
pre-oxidizing the ore concentrate and the grounded ore using the oxidant and the oxygen vector to obtain a slurry; and
feeding the slurry to the leaching step.

4. The process of claim 1, wherein the metal is gold, copper, lead, nickel, zinc or cobalt.

5. The process of claim 1, wherein the leaching reagent is a cyanide salt or an alkaline.

6. The process of claim 5, wherein the cyanide salt is selected from one or ore of KCN, NaCN or Ca(CN)₂.

7. The process of claim 3, wherein the oxygen vector is dodecane, decane or hexadecane, wherein a weight percent of the oxygen vector in the pre-oxidation and/or cyanide leaching mixtures ranges from 1% to 6% by weight.

8. The process of claim 3, wherein the oxidant is a mixture of air, O₂ and H₂O₂.

9. The process of claim 1, wherein a temperature of operation ranges from 10° C.-70° C.

10. The process of claim 3, wherein a pH of the leaching process and/or pre-oxidation process ranges 1-4 and 8-11.5.

11. A process for recovery of gold from a grounded gold ore, comprising the step of leaching the grounded gold ore with a cyanide salt, an oxidant and an oxygen vector.

12. The process of claim 11, further comprising the steps of
floating the grounded gold ore to obtain a gold ore concentrate; and
feeding the gold ore concentrate to the leaching step.

13. The process of claim 12, further comprising the steps of
pre-oxidizing the gold ore concentrate and the grounded gold ore using the oxidant and the oxygen vector to obtain a slurry; and
feeding the slurry to the leaching step.

14. The process of claim 13, wherein the oxygen vector is dodecane, decane or hexadecane, wherein a weight percent of the oxygen vector in the pre-oxidation and/or cyanide leaching mixtures ranges from 1% to 6% by weight.

15. The process of claim 11, wherein the cyanide salt is selected from one or more of KCN, NaCN or Ca(CN)₂.

16. The process of claim 13, wherein a pH of the leaching and/or pre-oxidation is >9.

17. The process of claim 11, wherein a temperature of operation ranges from 10° C.-70° C.

18. The process of claim 13, wherein the oxidant is a mixture of air, O₂ and H₂O₂.

19. A process for recovery of a gold from a grounded gold ore, comprising the steps of
floating the grounded gold ore to obtain a gold ore concentrate;
pre-oxidizing the gold ore concentrate and the grounded gold ore using the oxidant and an oxygen vector and a mixture of air, O₂ and H₂O₂ to obtain a slurry; and
leaching the slurry, the gold ore concentrate and the grounded gold ore with NaCN, the oxygen vector and the mixture of air, O₂ and H₂O₂, wherein the oxygen vector is selected from dodecane, decane or hexadecane.

20. The process of claim 19, wherein a total percentage (%) increase of a gold recovery is 0.2%-1.6% with oxygen and oxygen vector versus oxygen injection only.
